(19) United States
(12) Patent Application Publication
(10) Pub. No.: US 2024/0069533 A1
(43) Pub. Date: Feb. 29, 2024

(54) MANAGEMENT METHOD AND MANAGEMENT DEVICE

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nissin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/229,831

(22) Filed: Aug. 3, 2023

(30) Foreign Application Priority Data
Aug. 24, 2022 (JP) 2022-133137

(51) Int. Cl. G05B 19/418

(52) U.S. Cl. CPC G05B 19/41865; G05B 2219/23102

(57) ABSTRACT

A management method for management of a CO2 emission amount emitted by production of a product in a production line where a first product and a second product are produced includes acquiring a power consumption amount consumed in the production line for a predetermined period, and calculating a CO2 emission amount for each product by allocating the power consumption amount based on a ratio of a total work time required to produce the first product in the production line during the predetermined period and a total work time required to produce the second product in the production line during the predetermined period.

### CROSS-REFERENCE TO RELATED APPLICATION

This application claims priority to Japanese Patent Application No. 2022-133137 filed on Aug. 24, 2022, incorporated herein by reference in its entirety.

### BACKGROUND

### 1. Technical Field

The present disclosure relates to a management method and a management device for managing a CO2 emission amount (hereinafter also simply referred to as a “product CO2 emission amount”) emitted by production of a product.

### 2. Description of Related Art

With growing awareness of environmental issues, there is growing interest in CO2 emission amounts emitted to produce a product that is distributed on the market. Therefore, companies sometimes calculate and manage CO2 emission amounts emitted for production of products. For example, Japanese Unexamined Patent Application Publication No. 2016-126372 discloses a method of calculating a CO2 emission amount in a transportation process of products (including materials and parts).

### SUMMARY

Among a CO2 emission amount emitted to produce a product, a CO2 emission amount emitted in a production process may be calculated based on an energy amount (that is, a power consumption amount) consumed in a production line that has produced the product. By dividing the CO2 emission amount calculated based on the energy amount consumed in the production line by a production quantity of the product, a CO2 emission amount per unit product can be calculated.

Here, in the same production line, a plurality of types of products may be produced (mixed flow production). Depending on the type of product, the time (work time) required for production in the production line may differ. Therefore, different types of products may require different energy amounts for production. In such cases, the above-described method cannot accurately calculate a CO2 emission amount per unit product. In addition, hereinafter, a production line in which a plurality of types of products is produced in the same production line is also referred to as a “mixed flow line”.

The present disclosure relates to accurately calculating a CO2 emission amount per unit product for products produced in a mixed flow line.

A first aspect of the present disclosure relates to a management method management of a CO2 emission amount emitted by production of a product in a production line where a first product and a second product are produced. The management method includes acquiring a power consumption amount consumed in the production line for a predetermined period, and calculating a CO2 emission amount for each product by allocating the power consumption amount based on a ratio of the total work time required to produce the first product in the production line during the predetermined period and the total work time required to produce the second product in the production line during the predetermined period.

According to the configuration described above, by dividing the power consumption amount of the production line in a predetermined period proportionally based on the ratio of the total work time required to produce the first products in the production line during the predetermined period and the total work time required to produce the second products in the production line during the predetermined period, the CO2 emission amount for each product, that is, the sum total of the CO2 emission amounts of the first products produced during the predetermined period and the sum total of the CO2 emission amounts of the second products produced during the predetermined period are calculated. By allocating the power consumption amount consumed in the production line in the predetermined period based on the ratio of the total work time, it is possible to calculate the CO2 emission amount for each product that reflects the work time. Then, for example, it is possible to calculate the CO2 emission amount per unit product for each product by dividing the calculated CO2 emission amount for each product by each production quantity produced in the above-described production line (mixed flow line) during the predetermined period. Therefore, it is possible to accurately calculate the CO2 emission amount per unit product for products produced in a mixed flow line.

The first aspect may further include dividing a first CO2 emission amount by a production quantity of the first product in the predetermined period to calculate a CO2 emission amount per unit product of the first product, and dividing a second CO2 emission amount by a production quantity of the second product in the predetermined period to calculate a CO2 emission amount per unit product of the second product. The CO2 emission amount for each product includes the first CO2 emission amount that is a sum of CO2 emission amounts of the first products produced in the production line during the predetermined period, and the second CO2 emission amount that is a sum of CO2 emission amounts of the second products produced in the production line during the predetermined period.

With the configuration described above, the CO2 emission amount per unit product of the first product can be calculated by dividing the first CO2 emission amount by the production quantity of the first product for the predetermined period, and the CO2 emission amount per unit product of the second product can be calculated by dividing the second CO2 emission amount by the production quantity of the second product in the predetermined period. Therefore, it is possible to accurately calculate the CO2 emission amount per unit product for products produced in a mixed flow line.

The first aspect may further include reading conversion information for converting a power consumption amount into a CO2 emission amount, and converting a power consumption amount consumed in the production line during the predetermined period into a CO2 emission amount using the conversion information.

With the configuration described above, it is possible to appropriately convert the power consumption amount consumed in the production line for the predetermined period into the CO2 emission amount.

A second aspect of the present disclosure relates to a management device configured to manage a CO2 emission amount emitted by production of a product in a production line where a first product and a second product are produced. The management device includes a storage device configured to store a work time for producing the first product in the production line and a work time for producing the second product in the production line, and a control device configured to calculate a CO2 emission amount for each product by allocating a power consumption amount consumed in the production line for a predetermined period based on a ratio of the total work time required to produce the first product in the production line during the predetermined period and the total work time required to produce the second product in the production line during the predetermined period.

With each aspect of the present disclosure, it is possible to accurately calculate the CO2 emission amount per unit product for products produced in a mixed flow line.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a management system according to an embodiment;

FIG. 2 is a functional block diagram of a control device in a management device;

FIG. 3 is a flowchart illustrating a processing procedure for calculating a unit CO2 emission amount, that is executed by the control device in the management device; and

FIG. 4 is a flowchart illustrating a processing procedure for reporting the unit CO2 emission amount, that is executed by the control device in the management device.

### DETAILED DESCRIPTION OF EMBODIMENTS

Hereinafter, an embodiment of the present disclosure will be described in detail with reference to the drawings. The same or corresponding parts in the drawings are denoted by the same reference numerals, and the description thereof will not be repeated.

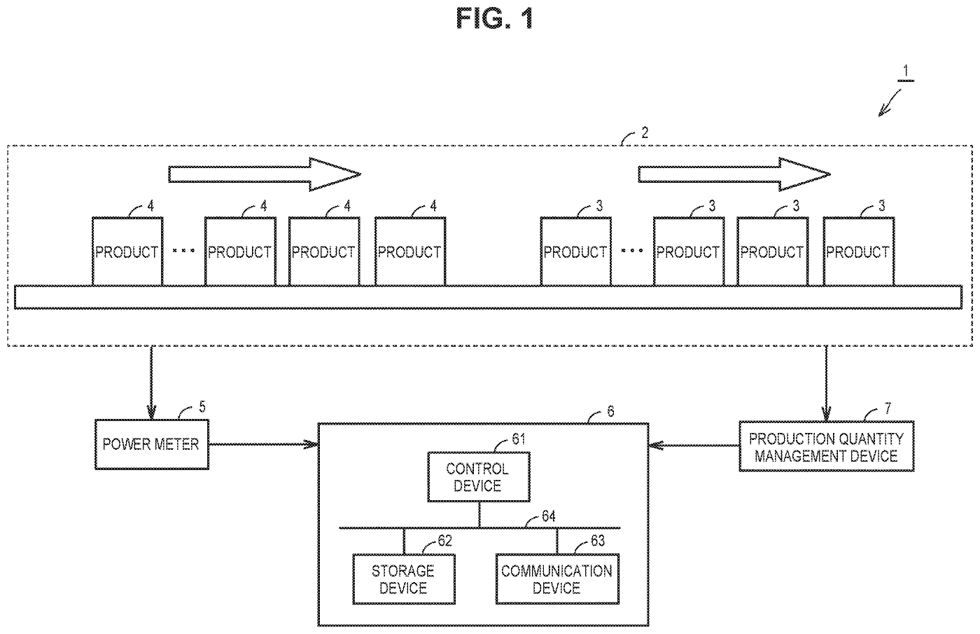

FIG. 1 is an overall configuration diagram of a management system 1 according to the present embodiment. The management system 1 is a system for managing a CO2 emission amount emitted from product production. The management system 1 is applied, for example, to a factory or the like. In the present embodiment, an example in which the management system 1 is applied to a production factory that produces parts will be described. The application of the management system 1 is not limited to a part production factory and can be applied to various product production factories such as finished product production factories and material production factories. That is, the type of product does not matter.

The management system 1 includes a production line 2, a power meter 5, a management device 6, and a production quantity management device 7. The management system 1 manages the CO2 emission amount of a product produced on the production line 2.

In the production line 2, a plurality of types of products is produced. That is, the production line 2 is a mixed flow line. In the present embodiment, two types of products, a product 3 and a product 4, are produced in the production line 2. The products 3, 4 are, for example, automobile parts. The products 3, 4 are different types of parts. In the production line 2, the product 3 and the product 4 are produced using, for example, different materials. In the present embodiment, the time required to produce the product 3 in the production line 2 and the time required to produce the product 4 in the production line 2 are different. The types of products produced in the production line 2 are not limited to two types. The number of types of products produced in the production line 2 may be three or more.

The production quantity management device 7 adds up the production quantity of products for each predetermined period for each product type. The predetermined period is, for example, 24 hours. The predetermined period is not limited to 24 hours, and can be set as appropriate. The production quantity management device 7 adds up a production quantity Na of the product 3 and a production quantity Nb of the product 4 in a predetermined period. The production quantity management device 7 may include, for example, an imaging device, and may add up the production quantity of products by analyzing images taken by the imaging device. Moreover, the production quantity management device 7 may include an input device, for example, and add up the production quantity of the product based on the operator's input to an input device. The production quantity management device 7 transmits the production quantity Na of the product 3 and the production quantity Nb of the product 4 in a predetermined period to the management device 6 at a predetermined time.

The power meter 5 measures the amount (power consumption amount) of power consumed in the production line 2. The power meter 5 measures the power consumed in the production line 2 and calculates a power consumption amount Etotal consumed in the production line 2 in a predetermined period. The power meter 5 transmits the power consumption amount Etotal to the management device 6 at a predetermined time. The power consumed by the production line 2 may be, for example, the power consumed in a factory building in which the production line 2 is installed. The power consumed in the factory building may include power for operating all equipment related to product production, such as air conditioning, lighting, a part transport vehicle (forklift or the like), a conveyor for the production line 2, an impact wrench, and assembly equipment. For example, when a plurality of production lines is installed in the factory building, the power consumed in the production line 2 may include power for operating equipment related to the production of products produced in the production line 2, and may not include power for operating equipment related to the production of products produced on other production lines.

At least one of the functions of the production quantity management device 7 and the power meter 5 can be provided to the management device 6. That is, the management device 6 may manage the number of products produced in the production line 2 or may measure the amount of power consumption in the production line 2.

The management device 6 reports the CO2 emission amount (the CO2 emission amount emitted by production of supplied products) required to produce the supplied products to a downstream company (company that receives products produced in the production line 2) in a supply chain. The management device 6 includes a control device 61, a storage device 62, and a communication device 63. The control device 61, the storage device 62, and the communication device 63 are connected to a bus 64.

The control device 61 includes, for example, a central processing unit (CPU), a memory, and an input/output port through which various signals are input/output (all not illustrated). The control device 61 executes various programs stored in the memory. Various programs include an operating system and the like. The memory includes, for example, a read only memory (ROM) that stores the various programs described above, and a random access memory (RAM) that functions as a working memory and temporarily stores various data necessary for executing the various programs.

The storage device 62 is configured to be able to store various types of information. The storage device 62 stores information on a work time of a product produced in the production line 2. The work time is a predetermined amount of time for producing one product in the production line 2. The work time is predetermined for each type of product based on the number of man-hours required to produce the product. Cycle time, takt time, for example, may be employed as work time. In the present embodiment, the storage device 62 stores a work time Ta (hereinafter, it is also simply referred to as a “product 3 work time Ta”) for producing the product 3 and a work time Tb (hereinafter, it is also simply referred to as a “product 4 work time Tb”) for producing the product 4.

The storage device 62 further stores a conversion formula (conversion information) for converting the power consumption amount into the CO2 emission amount. The conversion formula may be, for example, the power consumption amount multiplied by a CO2 emission factor. The CO2 emission factor is provided by, for example, a power supplier (a power company). The conversion formula is stored in the storage device 62. The conversion formula stored in the storage device 62 is updated by the control device 61, for example, when the CO2 emission factor is updated.

The communication device 63 is configured to communicate with devices (not illustrated) of downstream companies in the supply chain. Communication between the communication device 63 and devices of downstream companies is performed via, for example, the Internet. Also, the communication device 63 is configured to communicate with the production quantity management device 7 and the power meter 5. Communication between the communication device 63 and the production quantity management device 7 and the power meter 5 may be wired communication or wireless communication.

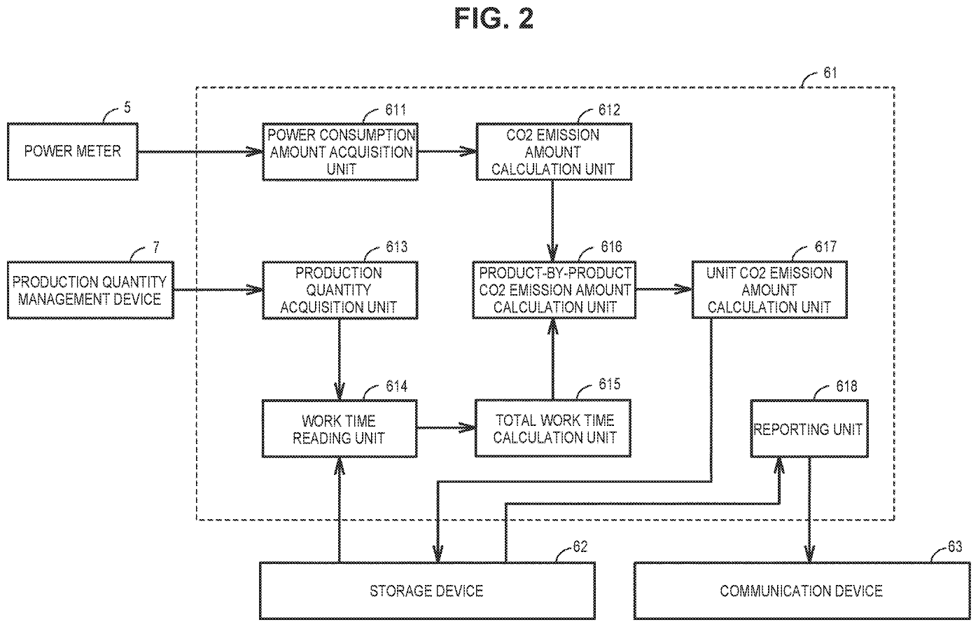

FIG. 2 is a functional block diagram of the control device 61 in the management device 6. The control device 61 includes a power consumption amount acquisition unit 611, a CO2 emission amount calculation unit 612, a production quantity acquisition unit 613, a work time reading unit 614, a total work time calculation unit 615, a product-by-product CO2 emission amount calculation unit 616, a unit CO2 emission amount calculation unit 617, and a reporting unit 618. The control device 61 functions as the power consumption amount acquisition unit 611, the CO2 emission amount calculation unit 612, the production quantity acquisition unit 613, the work time reading unit 614, the total work time calculation unit 615, the product-by-product CO2 emission amount calculation unit 616, the unit CO2 emission amount calculation unit 617, and the reporting unit 618, for example, by executing the programs stored in the memory. The power consumption amount acquisition unit 611, the CO2 emission amount calculation unit 612, the production quantity acquisition unit 613, the work time reading unit 614, the total work time calculation unit 615, the product-by-product CO2 emission amount calculation unit 616, the unit CO2 emission amount calculation unit 617, and the reporting unit 618 may be realized by dedicated hardware (electronic circuit), for example.

The power consumption amount acquisition unit 611 acquires the power consumption amount Etotal of the production line 2 in a predetermined period from the power meter 5. The power consumption amount acquisition unit 611 outputs the power consumption amount Etotal to the CO2 emission amount calculation unit 612.

The CO2 emission amount calculation unit 612 reads the conversion formula from the storage device 62. The CO2 emission amount calculation unit 612 inputs the power consumption amount Etotal into the conversion formula to calculate a CO2 emission amount Qtotal emitted in the production line 2 in a predetermined period. The CO2 emission amount calculation unit 612 outputs the CO2 emission amount Qtotal to the product-by-product CO2 emission amount calculation unit 616.

The production quantity acquisition unit 613 acquires, from the production quantity management device 7, the production quantity of each product (product 3 and product 4) produced in the production line 2 during a predetermined period. Specifically, the production quantity acquisition unit 613 acquires the production quantity Na of the product 3 and the production quantity Nb of the product 4 from the production quantity management device 7. The production quantity acquisition unit 613 outputs the production quantity Na and the production quantity Nb to the work time reading unit 614. The production quantity acquisition unit 613 may output the production quantity Na and the production quantity Nb to the total work time calculation unit 615.

The work time reading unit 614 reads the product 3 work time Ta and the product 4 work time Tb from the storage device 62. The work time reading unit 614 outputs the work times Ta, Tb and the production quantities Na, Nb to the total work time calculation unit 615.

The total work time calculation unit 615 uses the work times Ta, Tb and the production quantities Na, Nb to calculate the total work time, that is a sum of the work time for each product in a predetermined period. Specifically, the total work time calculation unit 615 multiplies the work time Ta by the production quantity Na to calculate a total work time Tasum, that is the total work time required to produce the products 3 in the production line 2 in a predetermined period. The total work time calculation unit 615 multiplies the work time Tb by the production quantity Nb to calculate a total work time Tbsum, that is the total work time required to produce the products 4 in the production line 2 in a predetermined period. The total work time calculation unit 615 outputs the total work times Tasum, Tbsum to the product-by-product CO2 emission amount calculation unit 616.

The product-by-product CO2 emission amount calculation unit 616 calculates a CO2 emission amount Qatotal emitted by production of the products 3 in a predetermined period and a CO2 emission amount Qbtotal emitted by production of the products 4 in a predetermined period based on a ratio of the total work times Tasum, Tbsum required to produce the products 3, 4 in a predetermined period. Specifically, the product-by-product CO2 emission amount calculation unit 616 calculates the CO2 emission amount Qatotal and the CO2 emission amount Qbtotal using the following formulas (1) and (2), respectively.

Qatotal=Qtotal×Tasum/(Tasum+Tbsum) (1)

Qbtotal=Qtotal×Tbsum/(Tasum+Tbsum) (2)

The product-by-product CO2 emission amount calculation unit 616 outputs the CO2 emission amounts Qatotal, Qbtotal to the unit CO2 emission amount calculation unit 617. The product-by-product CO2 emission amount calculation unit 616 may store the CO2 emission amounts Qatotal, Qbtotal in the storage device 62.

The unit CO2 emission amount calculation unit 617 calculates a unit CO2 emission amount Qa of the products 3 produced in a predetermined period and a unit CO2 emission amount Qb of the products 4 produced in a predetermined period. The unit CO2 emission amount is the CO2 emission amount per unit product. Specifically, the unit CO2 emission amount Qa is the CO2 emission amount per one product 3 (per unit product 3). The unit CO2 emission amount Qb is the CO2 emission amount per one product 4 (per unit product 4). The unit CO2 emission amount calculation unit 617 calculates the unit CO2 emission amounts Qa, Qb using the following formulas (3) and (4), respectively.

Qa=Qatotal/Na (3)

Qb=Qbtotal/Nb (4)

Each product 3 produced in the production line 2 is given an identification number. The unit CO2 emission amount calculation unit 617 stores the unit CO2 emission amount Qa in the storage device 62 in association with each identification number of the product 3 produced in the production line 2. The storage device 62 stores a CO2 emission amount Qaall required to produce the product 3 (single unit). The CO2 emission amount Qaall required to produce the product 3 (single unit) is calculated by adding the unit CO2 emission amount Qa to a CO2 emission amount Qapre required to procure raw materials for parts that make up the product 3 and to produce and transport the parts. When the unit CO2 emission amount calculation unit 617 stores the unit CO2 emission amount Qa in the storage device 62, the unit CO2 emission amount Qa is added to the CO2 emission amount Qapre, and the CO2 emission amount Qaall is updated. Also, each product 4 produced in the production line 2 is given an identification number. The unit CO2 emission amount calculation unit 617 stores the unit CO2 emission amount Qb in the storage device 62 in association with each identification number of the product 4 produced in the production line 2. The storage device 62 stores a CO2 emission amount Qball required to produce the product 4 (single unit). The CO2 emission amount Qball required to produce the product 4 (single unit) is calculated by adding the unit CO2 emission amount Qb to a CO2 emission amount Qbpre required to procure raw materials for parts that make up the product 4 and to produce and transport the parts. When the unit CO2 emission amount calculation unit 617 stores the unit CO2 emission amount Qb in the storage device 62, the unit CO2 emission amount Qb is added to the CO2 emission amount Qbpre, and the CO2 emission amount Qball is updated. The CO2 emission amounts Qapre, Qbpre are pre-stored in the storage device 62 after receiving reports from upstream companies.

For example, it is assumed that the product 3 is delivered to a downstream company. In this case, in response to a request from the downstream company, or triggered by the delivery of the product 3, the reporting unit 618 reads the CO2 emission amount Qaall of the product 3 from the storage device 62 using the identification number of the product 3 delivered to the downstream company as a key. Then, the reporting unit 618 outputs to the communication device 63 information for specifying the product 3 delivered to the downstream company and a control signal for transmitting the CO2 emission amount Qaall of the product 3 to a device of the downstream company. As a result, the information for specifying the product 3 delivered to the downstream company and the information on the CO2 emission amount Qaall of the product 3 are reported to the downstream company via the communication device 63. In addition, the information for specifying the product 3 delivered to the downstream company should be information that allows the downstream company to specify which product the reported CO2 emission amount Qaall belongs to, and the information may be, for example, the identification number described above, or a delivery number described on a delivery slip or the like.

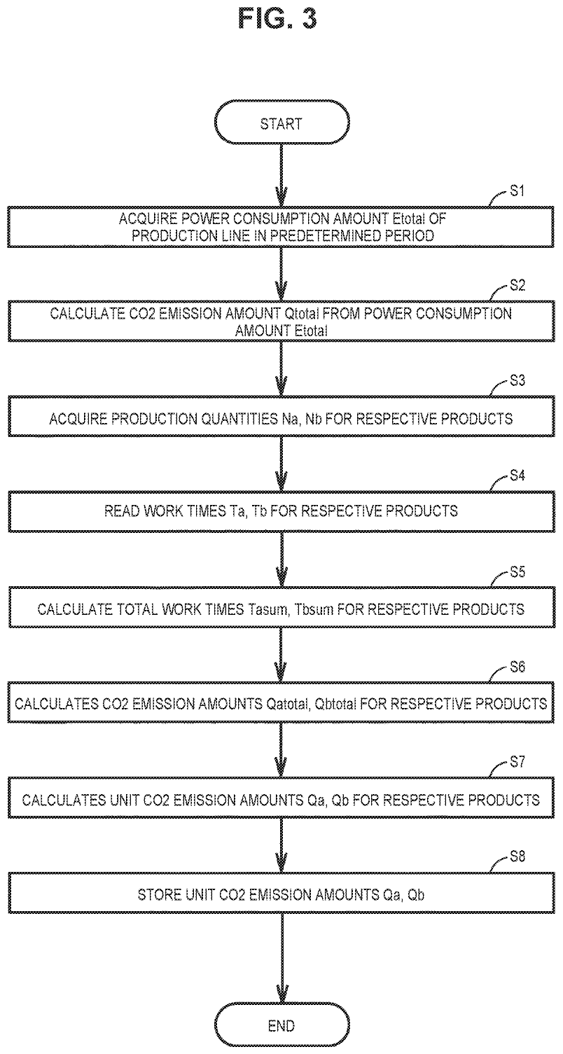

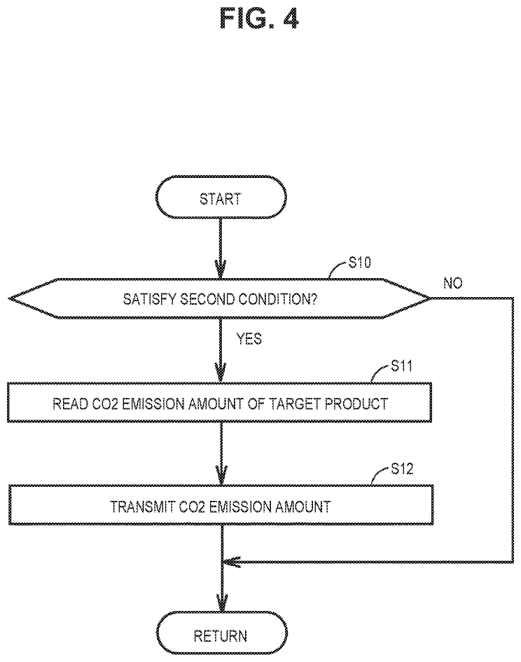

FIG. 3 is a flowchart illustrating a processing procedure for calculating the unit CO2 emission amount, that is executed by the control device 61 in the management device 6. This flow chart is started by the control device 61 when a first condition is established. The first condition may be, for example, that a predetermined period has elapsed since the last execution of a process. For example, when the predetermined period is 24 hours, the first condition can be the passage of one day (for example, change of date). Although the case is described where steps (hereinafter, step is abbreviated as “S”) of the flowchart illustrated in FIG. 3 and FIG. 4 described below are realized by software processing of the control device 61, a part or all of the steps may be realized by hardware (electric circuit) manufactured in the control device 61.

In S1, the control device 61 acquires the power consumption amount Etotal of the production line 2 in a predetermined period from the power meter 5.

In S2, the control device 61 reads the conversion formula from the storage device 62, inputs the power consumption amount Etotal into the conversion formula, and calculates the CO2 emission amount Qtotal emitted in the production line 2 in a predetermined period.

In S3, the control device 61 acquires, from the production quantity management device 7, the production quantity Na of the products 3 and the production quantity Nb of the products 4 produced in the production line 2 during the predetermined period.

In S4, the control device 61 reads the product 3 work time Ta and the product 4 work time Tb from the storage device 62.

In S5, the control device 61 multiplies the work time Ta and the production quantity Na to calculate the total work time Tasum, that is the total work time required to produce the products 3 in the production line 2 in the predetermined period. Further, the control device 61 multiplies the work time Tb and the production quantity Nb to calculate the total work time Tbsum, that is the total work time required to produce the products 4 in the production line 2 in the predetermined period.

In S6, the CO2 emission amount Qatotal emitted by production of the products 3 in the predetermined period and the CO2 emission amount Qbtotal emitted by production of the products 4 in the predetermined period are calculated by the control device 61 based on the ratio of the total work times Tasum, Tbsum required to produce the products 3, 4 in the production line 2 in the predetermined period. The control device 61 calculates the CO2 emission amounts Qatotal, Qbtotal respectively according to the above-described formulas (1), (2).

In S7, the control device 61 calculates the unit CO2 emission amount Qa of the products 3 produced in the predetermined period and the unit CO2 emission amount Qb of the products 4 produced in the predetermined period. The control device 61 calculates the unit CO2 emission amounts Qa, Qb respectively according to the above-described formulas (3), (4).

In S8, the control device 61 stores the unit CO2 emission amount Qa in the storage device 62 in association with the identification number of each product 3 produced in the predetermined period. Further, the control device 61 stores the unit CO2 emission amount Qb in the storage device 62 in association with the identification number of each product 4 produced in the predetermined period. Thereby, the CO2 emission amount Qaall of the product 3 and the CO2 emission amount Qball of the product 4 are updated.

FIG. 4 is a flowchart illustrating a processing procedure for reporting the unit CO2 emission amount, that is executed by the control device 61 in the management device 6. This flowchart is repeatedly executed by the control device 61 at predetermined intervals.

In S10, the control device 61 determines whether a second condition is satisfied. The second condition may be, for example, at least one of the following: (i) the product produced in the production line 2 was delivered to a downstream company, and (ii) the product produced in the production line 2 was delivered to a downstream company, and the downstream company requested disclosure of information on the CO2 emission amount of the delivered product (target product). When the control device 61 determines that the second condition is satisfied (YES in S10), the process proceeds to S11. When the control device 61 determines that the second condition is not satisfied (NO in S10), the process starts over.

In S11, the control device 61 reads the CO2 emission amount of the product (target product) from the storage device 62 using the identification number of the target product as a key.

In S12, the control device 61 outputs, to the communication device 63, a control signal for transmitting the information on the CO2 emission amount read in S11 to the device of the downstream company together with the information for specifying the target product (the product delivered to the downstream company). As a result, information for specifying the target product and information on the CO2 emission amount of the product are transmitted to the downstream company via the communication device 63.

As described above, in the management system 1 according to the present embodiment, the CO2 emission amount Qtotal emitted in the production line 2 during a predetermined period is proportionally divided (allocated) between the CO2 emission amount Qatotal emitted by the production of the products 3 and the CO2 emission amount Qbtotal emitted by the production of the products 4 based on the ratio of the total work times Tasum, Tbsum required to produce the products 3 and 4 in the production line 2 in the predetermined period,

Since the time (work time) required for production differs depending on the type of product, the amount of energy required for production differs for each type of product. Therefore, in a mixed flow line that produces a plurality of types of products in the same production line, with a method that simply proportionally divides (allocates) the CO2 emission amount Qtotal emitted in the production line 2 by production quantities, it is not possible to accurately calculate the unit CO2 emission amount for each type of product.

In the management system 1 according to the present embodiment, by dividing the CO2 emission amounts Qatotal, Qbtotal, which are calculated based on the ratio of the total work times Tasum, Tbsum required to produce the products 3 and 4 in the production line 2 in a predetermined period, respectively by the production quantity Na of the product 3 and the production quantity Nb of the product 4 produced in the production line 2 in the predetermined period, the unit CO2 emission amount Qa of the product 3 and the unit CO2 emission amount Qb of the product 4 are calculated. This makes it possible to accurately calculate the unit CO2 emission amount for each product.

### First Modification Example

It is also conceivable to form a consortium among companies involved in the supply chain and share information between companies using distributed ledger technology. In this case, the management device 6 may function as a node and form a distributed ledger network with nodes of downstream companies. The management device 6 (node) transmits transaction data to the distributed ledger network, including information on the CO2 emission amount of a target product to be reported to the downstream companies. By having the node of the downstream company approve this transaction data, the CO2 emission amount of the target product is reported to the downstream company. Reporting the CO2 emission amounts using distributed ledger technology can make information more resistant to tampering. Even in the first modification example, the unit CO2 emission amount may be calculated by the same method as in the embodiment, and the CO2 emission amount of the product may be calculated.

### Second Modification Example

In the embodiment and the first modification example, an example in which a predetermined amount of time (for example, takt time) for producing one product in the production line 2 is used as a work time is described. However, the work time is not limited to the predetermined amount of time. As the work time, it is also possible to adopt the time (for example, cycle time) actually required to produce the product in the production line 2.

In this case, the production quantity management device 7 adds up the production quantities of the products for each predetermined period for each type of product and stores the time required for production of each product. The management device 6 (control device 61) acquires the time required for production of each product from the production quantity management device 7, adds these up for each product type, and calculates the total work times Tasum, Tbsum. The control device 61 divides the total work times Tasum, Tbsum by the production quantities Na, Nb acquired from the production quantity management device 7, respectively. Thereby, the control device 61 calculates the work times Ta, Tb for each of the products 3 and 4 and stores them in the storage device 62.

The management device 6 calculates the CO2 emission amounts Qatotal, Qbtotal using the above-described formulas (1) and (2), as described in the embodiment (in other words, the CO2 emission amounts Qatotal, Qbtotal are calculated based on the ratio of the total work times Tasum, Tb sum required to produce the products 3 and 4 in the production line 2 in the predetermined period). By dividing the CO2 emission amounts Qatotal, Qbtotal respectively by the production quantity Na of the product 3 and the production quantity Nb of the product 4 produced in the production line 2 in the predetermined period, the management device 6 calculates the unit CO2 emission amount Qa of the product 3 and the unit CO2 emission amount Qb of the product 4.

In this way, even when the configuration according to the second modification example is employed, the same effects as those of the embodiment can be obtained. The second modification example can be combined with the first modification example.

It should be considered that the embodiment disclosed this time is illustrative in all respects and not restrictive. The scope of the present disclosure is indicated by the scope of the claims rather than the above description, and is intended to include all modifications within the scope and meaning of equivalents of the scope of the claims.

What is claimed is:

1. A management method for management of a CO2 emission amount emitted by production of a product in a production line where a first product and a second product are produced, the management method comprising:
acquiring a power consumption amount consumed in the production line for a predetermined period; and
calculating a CO2 emission amount for each product by allocating the power consumption amount based on a ratio of a total work time required to produce the first product in the production line during the predetermined period and a total work time required to produce the second product in the production line during the predetermined period.

2. The management method according to claim 1 further comprising:
dividing a first CO2 emission amount by a production quantity of the first product in the predetermined period to calculate a CO2 emission amount per unit product of the first product; and
dividing a second CO2 emission amount by a production quantity of the second product in the predetermined period to calculate a CO2 emission amount per unit product of the second product, wherein
the CO2 emission amount for each product includes the first CO2 emission amount that is a sum of CO2 emission amounts of the first products produced in the production line during the predetermined period, and the second CO2 emission amount that is a sum of CO2 emission amounts of the second products produced in the production line during the predetermined period.

3. The management method according to claim 1 further comprising:
reading conversion information for converting a power consumption amount into a CO2 emission amount; and
converting a power consumption amount consumed in the production line during the predetermined period into a CO2 emission amount using the conversion information.

4. A management device configured to manage a CO2 emission amount emitted by production of a product in a production line where a first product and a second product are produced, the management device comprising:
a storage device configured to store a work time for producing the first product in the production line and a work time for producing the second product in the production line; and
a control device configured to calculate a CO2 emission amount for each product by allocating a power consumption amount consumed in the production line for a predetermined period based on a ratio of a total work time required to produce the first product in the production line during the predetermined period and a total work time required to produce the second product in the production line during the predetermined period.
